(19) United States
(12) Patent Application Publication
(10) Pub. No.: US 2015/0151973 A1
(43) Pub. Date: Jun. 4, 2015

(54) COVALENTLY-BONDED GRAPHENE COATING AND ITS APPLICATIONS THEREOF

(71) Applicant: THE OHIO STATE UNIVERSITY, Columbus, OH (US)

(72) Inventors: Ly James Lee, Columbus, OH (US); Wenyi Huang, Midland, MI (US); Jianfeng Yu, Columbus, OH (US)

(73) Assignee: The Ohio State University, Columbus, OH (US)

(21) Appl. No.: 14/409,815

(22) PCT Filed: Jun. 25, 2013
(86) PCT No.: PCT/US13/47627

§ 371 Date: Dec. 19, 2014

Related U.S. Application Data
(60) Provisional application No. 61/690,373, filed on Jun. 25, 2012.

(51) Int. Cl. C01B 31/04

(52) U.S. Cl. CPC C01B 31/0446

(57) ABSTRACT

A facile method to produce covalently bonded graphene coating on various solid substrates is disclosed in the present invention. According to one embodiment, a combination of graphite, graphene oxide or graphene and silicon compound with or without a metal containing compound in an air free environment is processed at high temperatures to produce covalent carbide bonding among graphene layers and between graphene and substrate surface.

### CROSS-REFERENCE TO RELATED APPLICATIONS

This application claims the priority benefit of U.S. Provisional Application No. 61/690,373, filed Jun. 25, 2012, which is hereby incorporated by reference in its entirety.

### TECHNICAL FIELD OF THE INVENTION

Exemplary embodiments of the present invention relate to the coating of graphene nanosheets on the solid surfaces through thermal expansion and floating of graphene, graphene oxide or graphite powders, particulates, films or papers in an air free environment at elevated temperatures with the presence of silicon and/or metal containing compounds, which produced reactive species during this process to form covalent bonds among the graphene nanosheets and between the graphene layers and substrates. The solid surfaces include, but are not limited to, ceramic, quartz, glass, silicon wafer, glass and quartz fibers, metals, metal alloys or the like. At elevated temperatures, the solid surfaces were activated and then reacted with the reactive species to form covalent bonds with graphenes. The presence of covalently-bonded graphene coating on their surfaces makes non-conductive substrates thermally and electrically conductive and hydrophilic surfaces hydrophobic. It allows multiple graphene layers to be strongly bounded on solid surfaces by covalent bonds to achieve high temperature stability. Such coating also provides excellent corrosion resistance, low surface friction and useful semi-conductive and optical properties. By adjusting the content and type of graphene/graphene oxide/graphite, silicon and metal containing compounds, the aforementioned coating properties can be tuned. The present invention provides articles and coating useful in electromagnetic interference shielding, corrosion resistance, surface friction reduction, surface binding reduction, electric heating, and as components of semiconductor, solar cell and optical devices.

### BACKGROUND OF THE INVENTION

Carbon allotropes encompass 0-D fullerenes, 1-D nanotubes, 2-D graphenes, and 3-D graphite and diamond, among which graphenes are of particular interests due to their unique features. The 2-D graphenes are one-atom thick nanosheet composed of hexagonal structure of carbon atoms, giving rise to exceptional electrical conductivity (8×10⁵ S/m), high thermal conductivity (about 5300 W m⁻¹ K⁻¹), large surface areas (>2600 m²/g), strong mechanical properties (tensile strength of 130 GPa and Young's modulus of 1 TPa), low friction coefficient and excellent corrosion resistance.

The possible low-cost production of graphenes from graphite via oxidation-intercalation, exfoliation and reduction processes makes it an attractive conductor for many purposes. High-degree dispersion of graphenes in the polymer matrix can be realized, but it is not accessible for ceramics, glass, metals and semi-conductor materials because they are processed at temperatures above 400° C., at which graphenes are not thermally stable. Therefore, it is of particular importance to coat the surfaces of those solids with a thin layer of graphene to gain many, if not all, of its advantages.

Since the graphene surface is very inert, individual graphene layers can be easily peeled off from a multi-layer stack and direct coating of graphene layers on the surface of solids requires the use of adhesives, which often cannot withstand high temperatures. Furthermore, the presence of adhesives may reduce the graphene properties.

In the present invention, we describe a novel approach to coat the solid surfaces with graphene nanosheets at elevated temperatures, during which graphene nanosheets are released from graphite, graphene oxide or graphene powders, particles, films or papers, and deposited on the surface of solid substrates. In the presence of silicon, metal and sometimes a small amount of oxygen, the edge carbon atoms of graphene nanosheets may form covalent bonds such as (—C—O—Si—), (—C—Si—), (—C—O-M-) and/or (—C-M-) among themselves and with the silicon and/or metal atoms in the ceramics, glass, quartz, silicon wafer and metals. Some bonds formed on the basal planes cannot be ruled out either. Because of this, the coated graphene nanosheets have strong bonding among themselves and with the solid substrates, which can withstand high stresses and high temperatures even in the air. This graphene coating endows the solids with unique properties, allowing them to prospect as an attractive material for a variety of potential applications.

As an example, the vast majority of useful ceramics, glass and quartz are electrical and thermal insulators. To make their surfaces electrically and thermally conductive, a coating layer comprised of a dispersion of noble metal powders, e.g., platinum, gold, or silver, to give the electrical conductivity in the order of 1,000 S/m is often applied. In spite of high cost, noble metals are still used to a great extent because non-noble metal powders such as copper, nickel, or aluminum, are easy to form high resistance surface oxides. The expense of noble metals and the disadvantages of using non-noble metal powders have prompted researchers to search for alternative approaches. The present invention of covalently-bonded graphene coating serves as an excellent solution.

In light of their high electrical and thermal conductivity, high mechanical strength, excellent resistance to acid and base, low friction, high hydrophobicity, tunable semi-conductive and optical properties, and strong bonding among graphene nanosheets and between graphene and ceramics, glass and quartz, the covalently-bonded graphene coating of ceramics, glass and quartz can find many applications. For example, the current collector of the energy conversion devices is often exposed to an extremely corrosive environment. Because of the severe corrosion problems, many metals are not practical for such use. The covalently-bonded graphene coating of ceramics, glass and quartz are a promising alternative.

Another example is the application for heat-dissipation systems of microelectronic packaging. As the speed of processor increases, the generated heat would dramatically increase. Thus, the application of high thermal conductivity materials is essential to thermal management in compact packaging systems. Since graphene has a very high thermal conductivity, the graphene coated solids may be used there.

Because graphene has a very low friction coefficient, the covalently-bonded graphene coating of solids can be used as ball bearing and for many friction and binding reduction applications. A combination of high thermal conductivity, desirable electric conductivity/resistivity and low binding surface makes the covalently-bonded graphene coating of ceramics, glass and quartz an excellent material choice for energy saving and non-sticking cook ware.

### SUMMARY OF THE INVENTION

Exemplary embodiments of the present invention relate to produce covalently-bonded graphene coating on various solid substrates using a combination of graphene, graphene oxide or graphite and a silicon material with or without metal containing compounds in an air free environment, preferably under vacuum, at high temperatures. The solid substrates may be ceramics, glass, quartz, silicon wafers, metals, metal alloys or any solid materials which can stand high temperatures. They can be in shapes such as plates, fibers, spheres, films or any regular or irregular shapes. The graphite or graphene containing materials can be graphite powders or particles with or without functionalization, graphene oxide powders, particles, films or papers with or without functionalization, and graphene powders, particles, films or papers with or without functionalization. The silicon and metal containing compounds can be, but not limited to, silicon- containing polymers with and without fillers, cyano-containing polymers or compounds, metal halide, and metallocenes.

The solid substrates, the graphite or graphene containing materials, and the silicon/metal containing compounds are placed in an air free environment such as a vacuum furnace at temperatures ranging from 750 to 1200° C., preferably 850 to 1000° C. When the temperature inside the air free environment reaches a high enough temperature, the silicon/metal containing compounds would vaporize and the graphite or graphene containing materials would expand and float to coat the surface of the solid substrates, which would be also activated under this circumstance. It is believed that the edge carbon atoms of graphene nanosheets may form covalent bonds such as (—C—O—Si—), (—C—Si—), (—C—O-M-) or (—C-M-) among themselves and with the silicon and/or metal atoms in the substrate. It should be noticed that the silicon and metal containing compounds can be used alone without graphite/graphene oxide/graphene in this process to produce covalently-bonded silicon, silicon/metal, silicon oxycrabide or silicon carbide coating on the solid surface.

### BRIEF DESCRIPTION OF THE DRAWINGS

FIG. 1. A tube furnace with 2″ quartz tube, vacuum flange and 30 segments temperature controller.

FIG. 2. A representative reaction scheme for synthesizing functional graphenes.

FIG. 3. SEM images of (a) ceramic, (b) outer surface of a ceramic tube coated with a thin layer of covalently-bonded graphene, (c) outer surface of a ceramic tube coated with a thick layer of covalently-bonded graphene, and (d) inner surface of a ceramic tube coated with a thick layer of covalently-bonded graphene.

FIG. 4. Optical microscope image of the covalently-bonded graphene layer (dark color) on ceramic surface.

FIG. 5. Raman spectra of (a) ceramic, (b) functional graphene, (c) outer ceramic surface coated by covalently-bonded graphene, and (d) inner surface of ceramic coated by covalently-bonded graphene.

FIG. 6. XPS spectra for (a) C(1s) and (b) 0(1s) signals of graphene oxide (blue dashed line) and functional graphene (red solid line), and (c) S(2p) signal for functional graphene.

FIG. 7. XPS survey spectra for (a) functional graphene, (b) ceramic, (c) inner ceramic surface coated by covalently-bonded graphene, and (d) outer ceramic surface coated by covalently-bonded graphene.

FIG. 8. XPS spectra for (a) C(1s) and (b) O(1s) signal of ceramic (dark dashed line), functional graphene (blue dashed line), and inner surface of ceramic coated by functional graphene (red solid line).

FIG. 9. Photos of (a) a crucible and a cover coated by covalently-bonded graphene, and (b) two pieces of broken crucible with one heated at 1,000° C. in air for 1 hour (left) and one heated at 500° C. in air for 1 hour (right).

FIG. 10. Photos of (a) a crucible coated with gold doped and covalently-bonded graphene, (b) a crucible coated with copper doped and covalently-bonded graphene, (c) a crucible coated with covalently- bonded graphene without any metal doping.

FIG. 11. Photos of (a) a quartz plate, (b) a quartz plate coated with thick covalently-bonded graphene, and (c) a quartz plate coated with very thin covalently-bonded graphene to maintain good transparency.

FIG. 12. XRD spectra of (a) functional graphene, (b) quartz plate, and (c) quartz plate coated with thick covalently-bonded graphene.

FIG. 13. Photos of (a) glass fibers, and (b) glass fibers coated with covalently-bonded graphene.

FIG. 14. Photos of (a) a silicon wafer, and (b) a silicon wafer coated with covalently-bonded graphene.

### DETAILED DESCRIPTION OF EXEMPLARY EMBODIMENTS

In accordance with the foregoing summary, the following presents a detailed description of exemplary embodiments of the present invention, which are presently considered the best mode thereof.

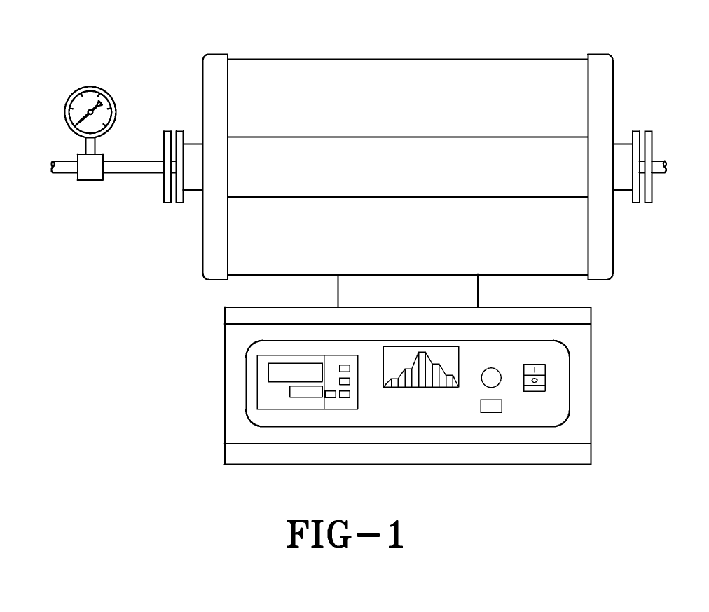

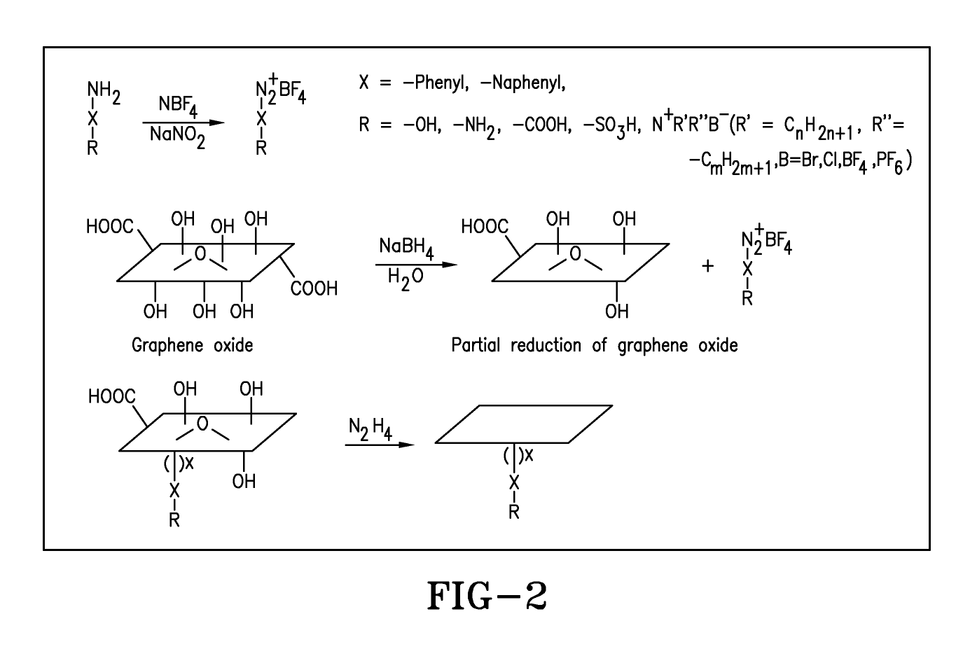

Various designs can be used to generate an air free environment which can reach high temperatures for the process. As an example, a tube furnace with a quartz tube and vacuum flange was employed for thermal treatment of solid substrates with graphene/graphene oxide/graphite materials and silicon/metal compounds as indicated in FIG. 1.

A broad range of solid substrates, graphene/graphene oxide/graphite materials and silicon or metal containing compounds can be used in the process. The following examples represent some, but not all, possible combinations.

### EXAMPLE 1

### Covalently-Bonded Graphene Coating of Ceramics

Expanded graphite (Superior Graphite Company) with a particle size distribution ranging from 10 to 50 μm was directly used for the purpose of surface coating. Graphite oxide was prepared by oxidizing the expanded graphite using concentrated sulfuric acid, fuming nitric acid, and potassium chlorate. Subsequently, graphene oxide was then achieved by dispersing graphite oxide in water, followed by sonication. Because graphene nanosheets tend to aggregate and form a precipitate agglomerate during reduction in solution due to π-π stacking interactions or restack after thermal shocking, chemical modification of graphene nanosheets are necessary for ensuring their solubility in water or organic solvents. We have developed a novel approach to synthesize functional graphenes with a variety of functional groups such as sulfonic acid, carboxylic acid, amine, cyano, tetrazole, or long flexible aliphatic groups, which were reported in our previous provisional patent. The graphite, graphene oxide or graphene nanopapers or films were prepared by filtration of the corresponding solution through a polycarbonate or anodic membrane or by solution casting , followed by drying in vacuum oven at 100-200° C. for 24 hours.

A tube-like ceramic piece was pre-placed inside the quartz tube with a piece of graphite, graphene oxide, or functional graphene film or nanopaper or a predetermined amount of graphite, graphite oxide, or functional graphene powders. A piece of silicon-containing polymer or cyano-containing polymer was placed in the quartz tube. Vacuum was applied to remove air inside the quartz tube and the temperature was quickly increased from room temperature to 400-600° C. under vacuum in 30 minutes. Vacuum was then turned off and the temperature was further increased to 800-1200° C. in 20 minutes. After the inside pressure of quartz tube was increased to atmospheric pressure, the vacuum valve was switched to a nitrogen gas inlet and the furnace was quickly purged and maintained at atmospheric pressure. After 10-30 minutes, the quartz tube was cooled down to room temperature before the treated ceramic part was removed from the quartz tube. The coated ceramic part was washed with water and acetone to remove ash on the coated surface.

During the thermal treatment, the functional group would degrade as temperature increased above 400-600° C. The produced organic species like benzene, CO₂, NO₂, SO₂ are large molecules, which are not easy to diffuse out from the nanopapers. As a result, they would expand the nanosheets. When the edge of the graphene nanopaper was etched by oxygen or other molecules at high temperatures such as 800-1200° C., the inner pressure inside the nanopaper would allow the individual graphene nanosheet to come out from the nanopaper, suspend in the quartz tube and finally deposit on the surface of pre-placed ceramic.

When the temperature inside the quartz tube reached a high enough temperature (700-900° C. in this case), the thermal degradation of pre-placed silicon-containing polymers or cyano-containing polymers would occur and the resulting gases would flow into the quartz tube. The composition of these gases may include Si(CH₃)—OH, H₂Si(CH₃)₂, CH₄, CO, and O₂, which were able to react with the edge carbons of graphene nanosheets. Since ceramics are composed of Si, C, O, N, etc, the edge of graphene nanosheets would have a great chance to form covalent bonds with ceramics at a temperature above 800-1200° C. After coating, hydrofluoric acid can be used to separate the coating layer from the ceramic substrate and reveal a free standing covalently-bonded graphene film.

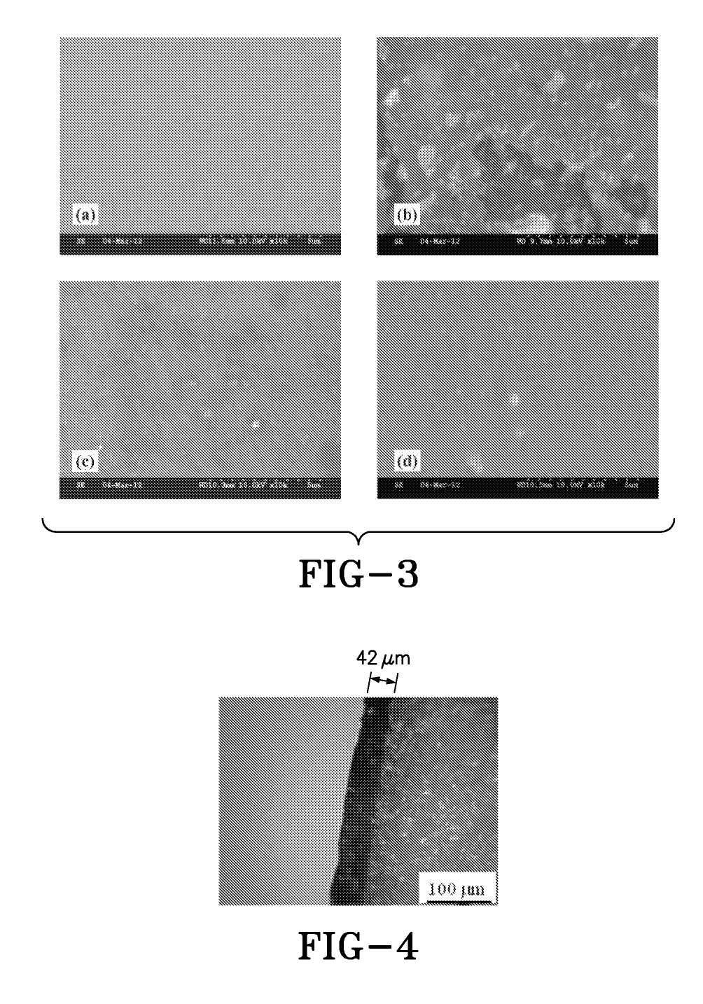

FIG. 3 shows the SEM images of a tube-like ceramic after graphene coating with a thinner coating layer on the outer surface and a thicker layer on the inner surface. It can be seen from FIG. 3a that the coated ceramic surface is very smooth. FIG. 3b shows the outer surface of graphene-coated ceramic with a thinner layer. Because the surface was not completely covered by the graphene layer, we can observe more detailed information about the coated morphology. The dark area is the ceramic substrate while the gray color layer is graphene. It is clear that there are some individual graphene nanosheets deposited on the ceramic surface. FIG. 3c shows the outer surface of graphene-coated ceramic with a thicker layer. Although there are still some dark areas, most of the surface is covered by the graphene layer. It can be observed from FIG. 3d that the inner surface of graphene-coated ceramic is complete because the nanopaper was placed inside the ceramic tube during the thermal treatment.

It can be seen from FIG. 4 that the thickness of the graphene layer in the graphene-coated ceramic is approximately 42 μm inside the tube and 10-20 μm outside the tube. Thus, the electrical conductivity of graphene-coated ceramic is about 86.6 S/m. The graphene coating is very strong. It cannot be removed by sharp knife or strong acids. The coating is stable up to 400° C., but can be oxygen-etched (i.e. burned) at temperatures higher than 400° C. for an extended time period (e.g. >1 hour), a typical characteristic of graphene/graphite materials. The graphene coating turned the ceramic surface from hydrophilic to hydrophobic with less friction resistance.

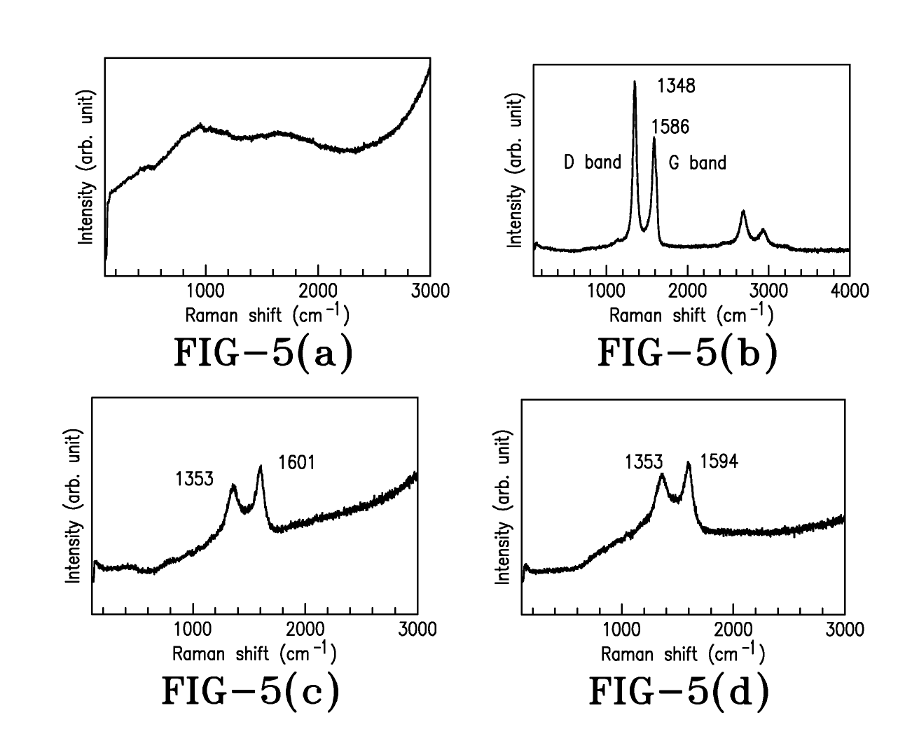

The Raman spectra of all samples were recorded using a Renishaw 1000 microspectrometer with an excitation wavelength of 514.5 nm. Raman spectroscopy is a useful nondestructive tool to characterize graphene materials, particularly for distinguishing ordered and disordered carbon structures, because Raman scattering is strongly sensitive to the change of electronic structure in the carbon materials. As seen from FIG. 5a, the ceramic has strong photoluminescence which contributes to the background of graphene-coated ceramic samples, especially for thin samples. In FIG. 5b, the Raman spectrum of functional graphene has a G band at 1586 cm⁻¹ and a D band at 1348 cm⁻¹. The integrated intensity ratio (I_{D}/I_{G}) for the D band and G band for the functional graphene is 1.3. The 2D band for the functional graphene locates at 2703 cm⁻¹ where there is another new peak appearing at 2934 cm⁻¹, which is assigned to D+G combination band. These two bands result from the disordered structure of the functional graphene. For graphene-coated ceramics (FIG. 5c,d), both G and D bands shift to higher wave numbers, and the I_{D}/I_{G} is less than 1, meaning that more sp² carbons were recovered because of the removal of functional groups at high temperatures. In the case of outer surface of the graphene-coated ceramic, G band is shifted to 1601 cm⁻¹ while D band is shifted to 1353 cm⁻¹.

For inner surface of graphene-coated ceramic, G band is shifted to 1594 cm⁻¹ while D band is shifted to 1353 cm⁻¹.

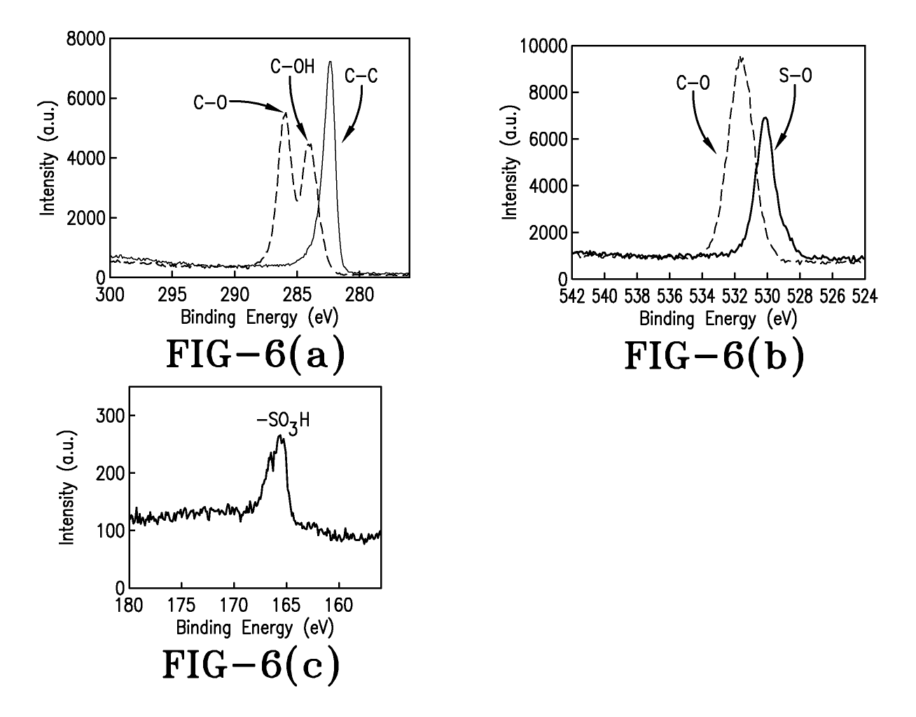

FIG. 6 shows the X-ray photoelectron spectra of C(1s) and O(1s) signals for graphene oxide and functional graphene. GO in FIG. 6a exhibits the main peak at a binding energy of 284.1 eV and another peak at 285.9 eV, that can be fit to peaks at 284.8, 285.6, and 286.7 eV and thus assigned to C—OH, C═O, and O═C—OH species, respectively. On the other hand, functional graphene shows only a single strong peak at a binding energy of 282.4 eV, which is assigned to C—C species. This demonstrates the loss of C—O and C═O functionalities on the surface of graphene by reduction. Nevertheless, the large full width at half maximum (FWHM) and a broad tail towards the higher binding energy imply contributions from a variety of different carbon bonding configurations. FIG. 6b exhibits strong O(1s) peaks at 531.7 and 530.1 eV for GO and functional graphenes, respectively. The O(1s) spectrum for GO can be fit to one peak at 530.7 eV assigned to C═O and O═C—OH groups, and another peak at 532.8 eV assigned to C—OH group. For functional graphene, the O(1s) signal primarily originates from the —SO₃ group without any C═O and O═C—OH signals. This again implies a very high degree of reduction during graphene formation, which can be attributed to the fact that functional graphenes were highly soluble in water so that hydrazine was able to access all graphene nanosheets to achieve complete reduction. FIG. 6c shows the S(2p) signal for functional at 165.6 eV, which can be fit to peaks at 165.7 eV assigned to S(2p¹) and 166.8 eV attributed to S(2p²). Clearly, functional groups have been successfully attached to the surface of graphene via C—C covalent bonds.

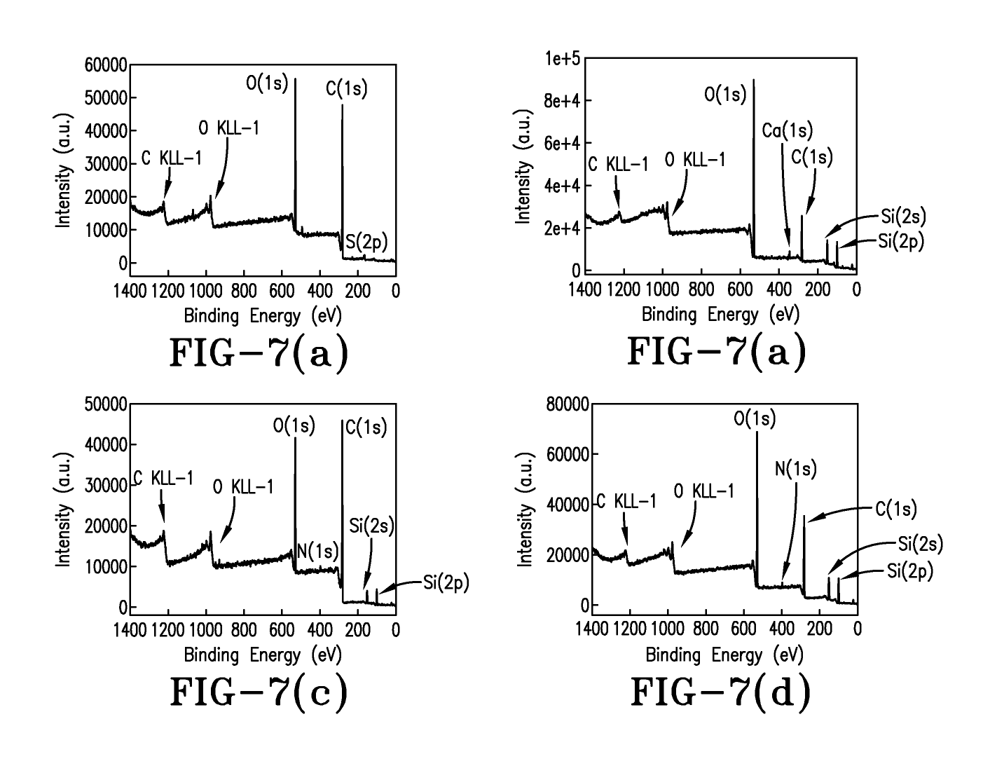

FIG. 7 shows the XPS survey spectra for functional graphene, ceramic, inner surface of graphene- coated ceramic, and outer surface of graphene-coated ceramic. As expected, the functional graphene is composed of oxygen, carbon, and sulfur elements (notice that XPS cannot detect hydrogen element), while ceramic is made of oxygen, carbon, silicon, and calcium elements. For the inner and outer surfaces of graphene-coated ceramic (FIGS. 7c and d), we can detect silicon element, which may come from the ceramic substrate or the covalently-bonded groups between the graphene interlayers, but cannot find the sulfur element, which may be completely removed during the thermal treatment.

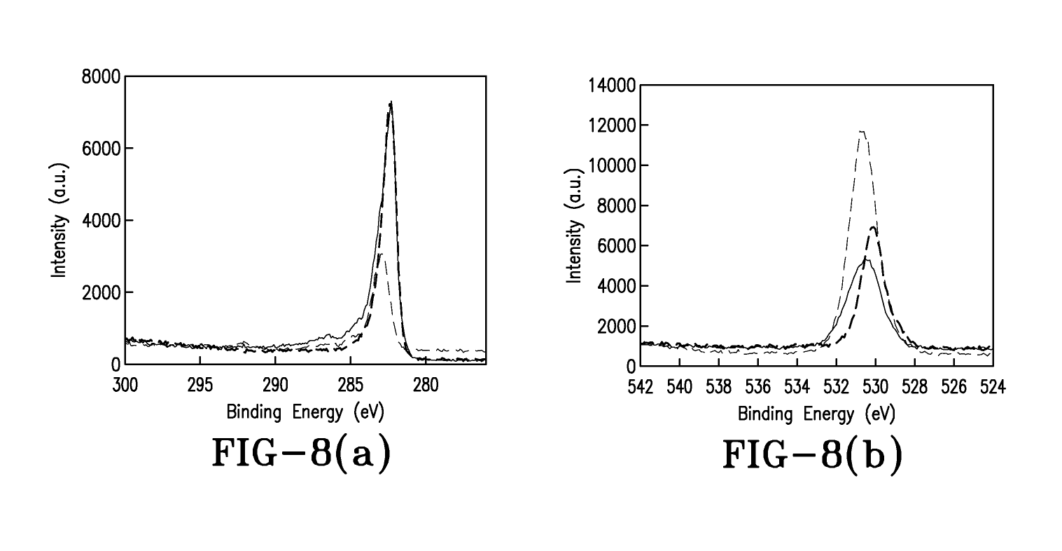

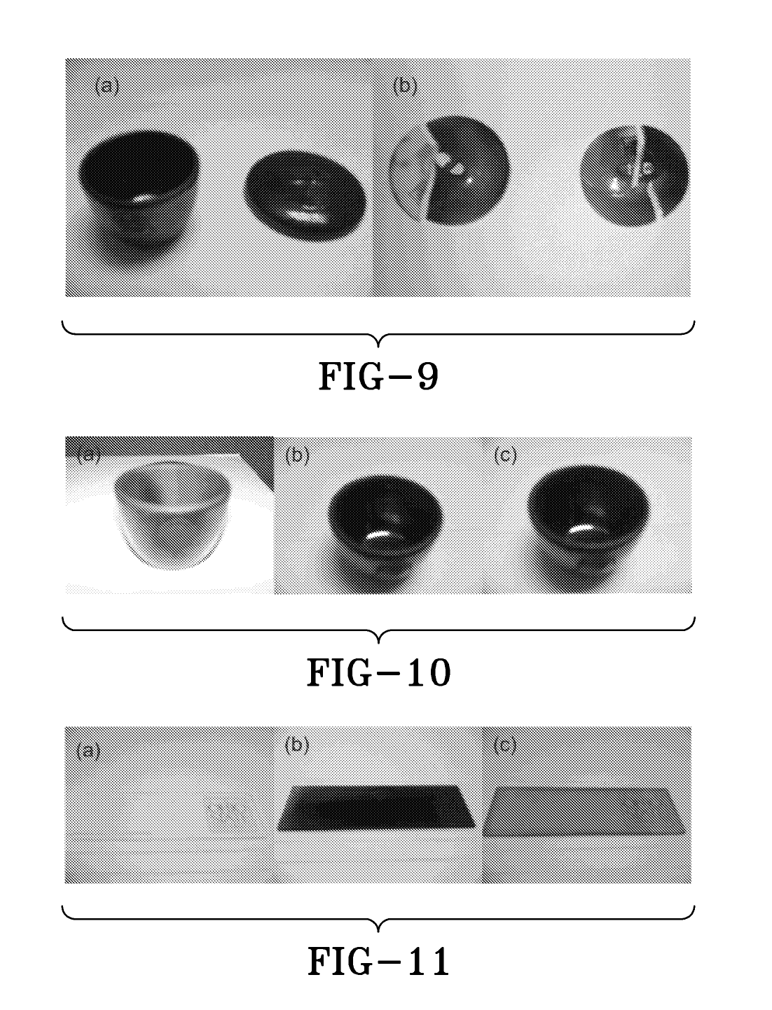

It can be seen from FIG. 8 that the C(1s) signal for C—C groups at a binding energy of 282.3 eV is almost superimposed over that of functional graphene for the inner surface of graphene-coated ceramic having a thicker graphene layer, whereas, the C(1s) signal for ceramic is located at 282.9 eV, which is assigned to C—O groups. Since the primary source of oxygen in functional graphene arise from the functional groups, its O(1s) signal appears at a binding energy of 530.1 eV. On the other hand, the O(1s) signals of ceramic and graphene-coated ceramic originate from the C—O or Si—O groups, and accordingly, their binding energy exhibits at 530.8 eV. For the outer layer of graphene-coated ceramic (FIG. 9) with thin graphene layer, the effect of ceramic background becomes more evident.

### EXAMPLE 2

### Covalently Bonded Graphene Coating of Crucible Using Chemically Functionalized Graphene Powder and Silicon O-Ring

Similar to Example 1, a crucible and its cover were placed in the quartz tube. Some functional graphene powder and a piece of silicon-containing polymer were placed in the vacuum flange. A similar thermal cycle was applied except that the maximum temperature of the furnace was set at 950° C. After coating, the crucible and its cover were cleaned with water and acetone. FIG. 9a shows the graphene-coated-crucible and cover. Again, the coating was stable below 400° C. in air, but could be completely removed at higher temperatures in the presence of oxygen as shown in FIG. 9b where part of the broken crucible coated with silicon carbide bonded graphene was heated at 500° C. for one hour.

### EXAMPLE 3

### Metal Doped and Silicon Carbide (and/or Silicon Oxycarbide) Bonded Graphene Coating of Crucible Using Graphite Oxide/Graphene Oxide, Silicon-Containing Polymers and Metal Containing Compounds

Similar to Example 1, a crucible was placed in the quartz tube with graphite oxide/graphene oxide, a piece of silicon- or cyano-containing polymer, and a piece of gold sprayed quartz plate (˜5 nm thick gold) or 5 mg copper halide placed in the vacuum flange. A similar thermal cycle was applied except that the maximum temperature of the furnace was set at 1000° C. The color of resulting crucible varied from golden yellow, brown to black depending on the content of different doping metals used. FIG. 10 shows photos of (a) a crucible coated with gold doped and carbide bonded graphene, (b) a crucible coated with copper doped and carbide bonded graphene, (c) a crucible coated with covalently-bonded graphene without any metal doping.

### EXAMPLE 4

### Silicon Carbide (and/or Silicon Oxycarbide) Bonded Graphene Coating of Quartz Plates Using Functional Graphenes and Silicon-Containing Polymers

Similar to Example 1, several 1/16″ thick quartz plates were placed in the quartz tube. Some functional graphenes and a piece of silicon-containing polymer were placed in the vacuum flange. A similar thermal cycle was applied except that the maximum temperature of the furnace was set at 900° C. By adjusting the graphene and silicon rubber content or the exposure time at 900° C., the coating thickness could be controlled for getting totally black or nearly transparent quartz plate. The optical and electronic properties of the coating can also be adjusted by adding a small amount of metal ion containing compounds. FIG. 11 shows photos of (a) a quartz plate, (b) a quartz plate coated with thick covalently- bonded graphene, and (c) a quartz plate coated with very thin covalently-bonded graphene to maintain good transparency.

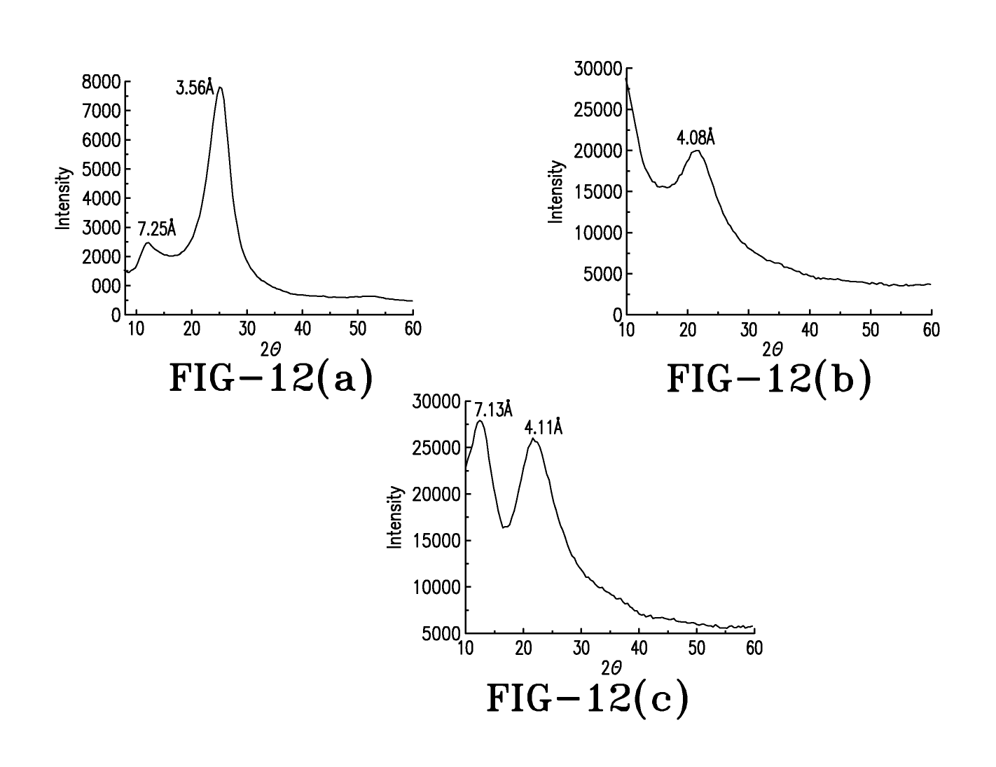

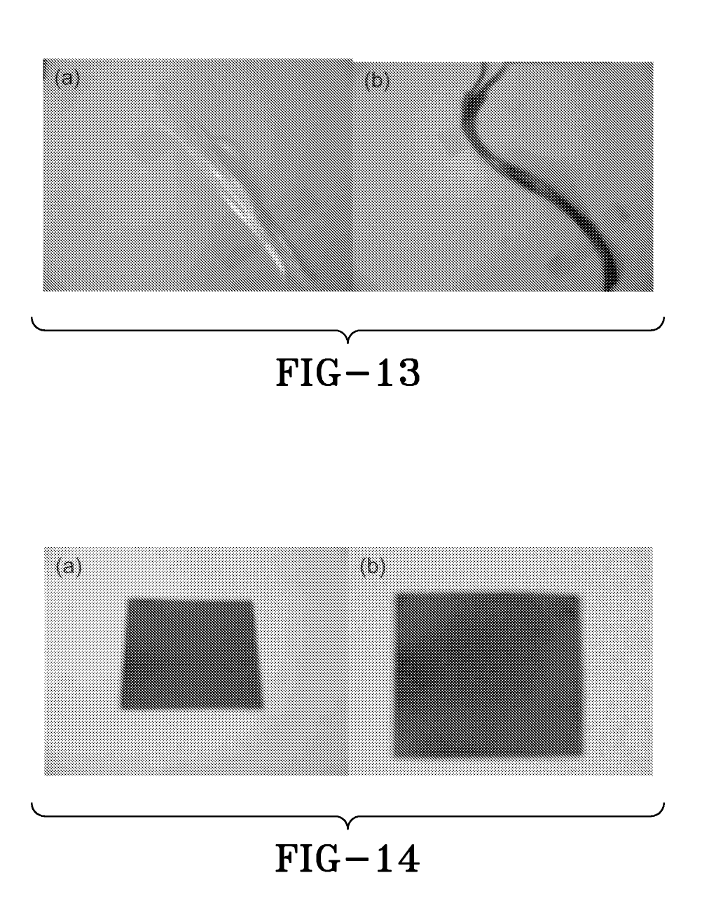

FIG. 12 shows the XRD spectra of (a) a functional graphene nanopaper, (b) a quartz plate, and (c) a quartz plate coated with thick covalently-bonded graphene Like the functional graphene, the quartz plate coated with thick covalently-bonded graphene also has 2 peaks in its XRD spectrum. One equivalent to an inter-gallery spacing of 7.1-7.2 Å reveals the similar packing of graphene nanosheets in both samples. The second peak equivalent to an inter-gallery spacing of 4.1 Å comes from the quartz plate. The 3.56 Å inter-gallery spacing showing in the graphene nanopaper is not observed in the graphene coated quartz plate, probably covered by the large peak from the quartz plate.

### EXAMPLE 5

### Silicon Carbide (and/or Silicon Oxycarbide) Bonded Graphene Coating of Glass Fibers Using Commercially Available Graphene Powder and Silicon-Containing Polymers

Similar to Example 1, a number of glass fibers were placed in the quartz tube. Some commercially available graphene powder made by the thermal shocking method and a piece of silicon-containing polymer were placed in the vacuum flange. A similar thermal cycle was applied except that the maximum temperature of the furnace was set at 750° C. After coating, we removed the glass fibers from the quartz tube, and then sonicated in a mixture of water/isopropanol for several minutes to clean ash over the fiber surface. FIG. 12 shows photos of (a) glass fibers and (b) glass fibers coated with silicon carbide bonded graphene.

### EXAMPLE 6

### Silicon Carbide (and/or Silicon Oxycarbide) Bonded Graphene Coating of Silicon Wafer Using Commercially Available Expanded Graphite Powder and Silicon-Containing Polymers

Similar to Example 1, several pieces of silicon wafer were placed in the quartz tube. Several milligrams of commercially available expanded graphite powder and a piece of silicon-containing polymer were placed in the vacuum flange. A similar thermal cycle was applied except that the maximum temperature of the furnace was set at 1080° C. After coating, we removed the silicon wafer from the quartz tube, clean the wafer with water and acetone. FIG. 14 shows photos of (a) a silicon wafer and (b) a silicon wafer coated with silicon carbide bonded graphene. The coating showed semi-conductive characteristics and its semi-conductive properties can be tuned by adjusting the content of graphite/graphene and silicon-containing polymer or by adding a small amount of metal containing compounds.

What is claimed is:

1. A method for coating the surfaces of different substrates with covalently-bonded graphenes via thermal expansion and floating of grapheme, grapheme oxide or graphite materials with the presence of silicon- or cyano- contaminating polymers with or without metal containing compounds at elevated temperatures.

2. Method of claim 1 in which said substrates are ceramics, quartz, glass, silicon wafer and metals at any shapes.

3. Method of claim 2 in which said metals include structural steels, carbon steels, copper, titanium and other metals and their alloys.

4. Method of claim 1 in which said silicon- or cyano-containing polymers include, but not limited to, silicone rubber, polydimethylsiloxane (PDMS), organosilicon, silane-grafted polymers (polyethylene, polypropylene or polystyrene), silicon-containing metallocene polymers, polyacrylonitrile, cyano-polyphenylene vinylene polymers, tetrazole-containing polymers, cyanophosphazene polymers.

5. Method of claim 1 in which said graphene materials are graphite powders or particles with or without functionalization, graphene oxide powders, particles, films or papers with or without functionalization, and graphene powders, particles, films or papers with or without functionalization.

6. Method of claim 1 in which said graphene materials can be thermally reduced or chemically reduced from graphene oxide.

7. Method of claim 1 in which said chemically reduced graphene can be prepared by Brodie/Staudenmaier method, Hummers method, Improved Hummers method, and other methods with partial or full reduction.

8. Method of claim 1 in which functionalization of graphene and graphene oxide include, but not limited to epoxy, hydroxyl, carboxyl acid, benzenesulfonic acid and amine groups.

9. Method of claim 1 in which said silicon and metal containing compounds can be, but not limited to, silicon-containing polymers with and without fillers, gold, copper halide, and metallocenes.

10. Method of claim 1 in which said covalent bonds includes (—C—O—Si—), (—C—Si—), (—C—N—), (—N-M-), (—C—O-M-) and/or (—C-M-) among the grapheme nanosheets and between graphene layers and solid substrates.

11. Method of claim 1 in which said thermal expansion and floating is realized through heating the graphene/graphene oxide/graphite materials and silicon and metal containing compounds to elevated temperatures in an air free environment, preferably vaccum, followed by purging with nitrogen or other non-oxygen gases before cooling to room temperature.

12. Method of claim 1 in which the elevated temperatures range from 750 to 1200° C., preferably from 850 to 1000° C.

13. Method of claim 1 in which said covalently-bonded graphene coating possess excellent mechanical strength, electrical and thermal conductivities, and strong binding to the solid substrates.

14. Method of claim 1 in which said covalently-bonded graphene coating is useful for aircrafts, electronics, marine applications, and so on.

15. Method of claim 1 in which said covalently-bonded graphene coating of silicon wafer, quartz and glass possesses tunable semi-conductive and optical properties.

16. Method of claim 1 in which said carbide bonded graphene coating of silicon wafer, quartz and glass can be used for solar cells, semiconductor components and optical devices.

17. Method of claim 1 in which said carbide bonded graphene coating has unique combination of anti-corrosion, anti-acid, anti-abrasion, and hydrophobic properties.

18. Method of claim 1 in which said carbide bonded graphene coating of ceramics, quartz, glass and metals can be used for cookware.

19. Method of claim 1 in which the substrates such as ceramics, quartz, glass, silicon wafer and copper foil can be etched away after coating to produce free standing covalently-bonded graphene films, sheets, hollow fibers and articles with various shapes.

20. Method of claim 19 in which the free standing covalently-bonded graphene films, sheets, hollow fibers and articles with various shapes can be used for electronics, transportation, composites, optical, energy and other applications.

21. Method of claim 1 in which the silicon and metal containing compounds can be used alone without graphite/graphene oxide/graphene to produce covalently-bonded silicon, silicon/metal, silicon oxycrabide or silicon carbide coating on the solid surface.
